(19) United States
(12) Patent Application Publication
(10) Pub. No.: US 2024/0410105 A1
(43) Pub. Date: Dec. 12, 2024

(54) DRYER

(71) Applicant: SAMSUNG ELECTRONICS CO., LTD., Suwon-si Gyeonggi-do (KR)

(72) Inventors: Sunghyun CHUN, Suwon-si (KR); Youngjae KIM, Suwon-si (KR); Myungwon JEON, Suwon-si (KR); Jaeik CHA, Suwon-si (KR); Hankyu CHOI, Suwon-si (KR)

(73) Assignee: SAMSUNG ELECTRONICS CO., LTD., Suwon-si Gyeonggi-do (KR)

(21) Appl. No.: 18/810,803

(22) Filed: Aug. 21, 2024

Related U.S. Application Data
(63) Continuation of application No. PCT/KR2023/002246, filed on Feb. 16, 2023.

(30) Foreign Application Priority Data
Feb. 24, 2022 (KR) 10-2022-0024318

(51) Int. Cl. D06F 58/20; D06F 105/34

(52) U.S. Cl. CPC D06F 58/20; D06F 2105/34

(57) ABSTRACT

A dryer includes: a main body which includes a front panel with an opening, an inlet and a base forming a bottom surface; a drum; and a heat exchanger accessible through the opening. The base includes a bottom portion on which the heat exchanger is seated and a front wall portion vertical to the bottom portion. The base includes a cover configured to open and close the opening, a filter unit, and a ground electrode on the front wall portion. The filter unit includes a fixer member coupleable to the front wall portion such that while the fixer member at a first position the filter unit is prevented from being separated, and while the fixer member is moved to a second position the filter unit is separable from the front wall portion. The fixer member is electrically connected to the ground electrode at the first position.

### CROSS-REFERENCE TO RELATED APPLICATION

This application is a continuation application, under 35 U.S.C. § 111 (a), of international application No. PCT/KR2023/002246, filed on Feb. 16, 2023, which claims priority under 35 U. S. C. § 119 to Korean Patent Application No. 10-2022-0024318, filed Feb. 24, 2022, the disclosures of which are incorporated herein by reference in their entireties.

### BACKGROUND

### Technical Field

The disclosure relates to a dryer having an improved structure for discharging static electricity charged to a user.

### Description of the Related Art

Generally, a dryer includes a cylindrical drum into which objects to be dried are placed, an air circulation device that circulates air in the drum, and a heat exchanger that heats medium-temperature and high-humidity air discharged from the drum into high-temperature and low-humidity air.

When a user cleans the heat exchanger, there is a problem that static electricity charged to the user may react with explosive refrigerant and ignite.

Summary According to an embodiment of the disclosure, a dryer may include a main body including a front panel including an opening and an inlet for inputting objects to be dried and a base forming a bottom surface; a drum rotatable inside the main body; and a heat exchanger configured to heat air supplied to the drum where the heat exchanger being accessible through the opening of the front panel. The base includes a bottom portion on which the heat exchanger is seated and a front wall portion vertical to the bottom portion. The base further includes a cover configured to open and close the opening; a filter unit coupleable to and decouplable from the front wall portion through the opening; and a ground electrode on the front wall portion. The filter unit includes a fixer member coupleable to the front wall portion such that while the fixer member is coupled to the front wall portion and while the fixer member is at a first position the filter unit is prevented from being separated from the front wall portion, and the while fixer member is moved to a second position from the first position the filter unit is separable from the front wall portion at a second position rotated from the first position. The fixer member may be electrically connected to the ground electrode at the first position.

The dryer may further include a wire member including one end electrically connected to the ground electrode and another end being grounded.

The fixer member may include a protruding area outside the filter unit at the first position and in contact with the ground electrode.

The fixer member may be configured to: connect to the filter unit whereby the fixer member is rotatable while connected to the filter unit, rotate from the first position in a first direction so as to move to the second position, and rotate from the second position in a second direction opposite to the first direction so as to move to the first position.

The fixer member may be configured to: rotate by 90 degrees in the first direction from the first position so as to move to the second position, and rotate by 90 degrees from the second position in the second direction opposite to the first direction so as to move the first position.

The fixer member may have an “L” shape.

The front wall portion may include a side wall that is disposed on one side of the filter unit and includes a through hole, and wherein one area of the fixer member may penetrate the through hole at the first position.

The fixer member may include chromium (Cr).

The fixer member may be adjacent to a first edge of the filter unit. The dryer may further include an additional fixer member, wherein the additional fixer member is connected to the front of the filter unit, is adjacent to a second edge opposite to the first edge of the filter unit, interferes with the front wall portion at a third position to fix the filter unit to the front wall portion, and enables the filter unit to be separated from the front wall portion at a fourth position.

The ground electrode may be formed of stainless steel (STS).

The dryer may further include: a sensor configured to detect whether the fixer member is in contact with the ground electrode; and a processor configured to identify that the filter unit is fastened to the front wall portion when detecting that the fixer member is in contact with the ground electrode through the sensor.

The dryer may further include: a magnet member on the filter unit; a sensor on the front wall portion to detect magnetic force of the magnet member; and a processor configured to identify that the filter unit is fastened to the front wall portion when a magnitude of the magnetic force of the magnet member received from the sensor is greater than or equal to a preset value.

### BRIEF DESCRIPTION OF THE DRAWINGS

FIG. 1 is a perspective view of a dryer according to an embodiment of the disclosure.

FIG. 2 is an exploded perspective view of a dryer according to an embodiment of the disclosure.

FIG. 3 is an exploded perspective view of a frame and a cover according to an embodiment of the disclosure.

FIG. 4 is a front view illustrating a state in which a fixer member is disposed in a first position according to an embodiment of the disclosure.

FIG. 5 is a front view illustrating a state in which a fixer member is disposed in a second position according to an embodiment of the disclosure.

FIG. 6 is a perspective view illustrating a state in which a fixer member is disposed in a first position according to an embodiment of the disclosure.

FIG. 7 is a perspective view illustrating a state in which an additional fixer member is disposed in a first position according to an embodiment of the disclosure.

FIG. 8 is a functional block diagram of a dryer according to an embodiment of the disclosure.

### DETAILED DESCRIPTION

Various embodiments described below are shown by way of example to assist understanding of the disclosure, and it should be understood that the disclosure may be variously modified and implemented differently from the embodiments described herein. However, in the following description of the disclosure, when it is determined that a detailed description of a related known function or components may unnecessarily obscure the gist of the disclosure, the detailed description and specific illustration thereof will be omitted. Further, in the accompanying drawings, the dimensions of some components may be arbitrarily exaggerated and not drawn to scale in order to aid understanding of the disclosure.

The terms used in the disclosure and the claims are general terms identified in consideration of the functions of the various embodiments of the disclosure. However, these terms may vary depending on intention, technical interpretation, emergence of new technologies, and the like of those skilled in the related art. Unless there is a specific definition of a term, the term may be understood based on the overall contents and technological understanding of those skilled in the related art.

In this disclosure, the terms such as “have”, “may have”, “include” or “may include” refer to a presence of the corresponding features (e.g., a numerical value, function, operation, or component such as a part), and does not preclude a presence of additional features.

In the disclosure, components required for the description of each embodiment of the disclosure are described and thus, the embodiment is not necessarily limited thereto. Accordingly, some components may be changed or omitted and other components may be added. In addition, components may be disposed and arranged in different independent devices.

Further, the embodiments of the disclosure will be described in detail with reference to the accompanying drawings and the contents described in the accompanying drawings, but the disclosure is not limited or limited by the embodiments.

The disclosure has been developed in order to solve the above-mentioned problems. An object of the disclosure is to provide a dryer with an improved structure for discharging static electricity charged on the user.

Hereinafter, the disclosure will be described in detail with reference to the accompanying drawings.

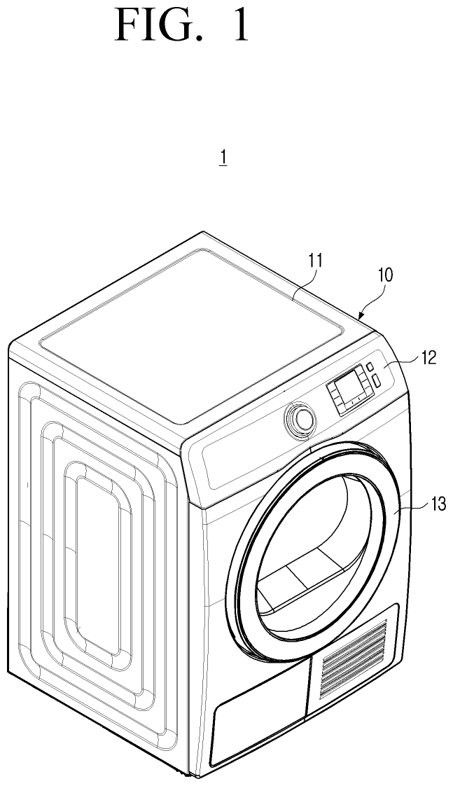

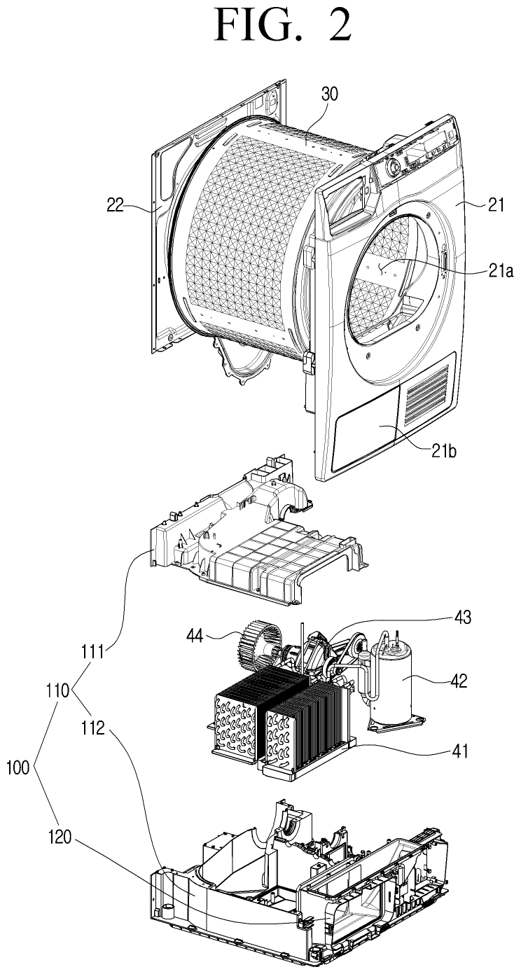

FIG. 1 is a perspective view of a dryer according to an embodiment of the disclosure. FIG. 2 is an exploded perspective view of a dryer according to an embodiment of the disclosure.

Referring to FIGS. 1 and 2, a dryer 1 according to an embodiment of the disclosure may include a main body 10, panels 21 and 22, a drum 30, a heat exchanger 41, and a base 100. The main body 10 forms the exterior of the dryer 1, and an inlet is provided at the front of the main body 10 to allow objects to be dried to be put into the drum 30. On one side of the inlet, a door 13 is hinged to the main body 10 to open and close the inlet 21a.

The main body 10 may include a top cover 11. The top cover 11 may be fixed to a front panel 21 and a rear panel 22.

A control panel 12 may be provided on the front of the main body 10. The user may control the dryer 1 through the control panel 12.

The main body 10 may include the front panel 21, the rear panel 22, and the base 100.

The front panel 21 may be provided with the inlet 21a for inputting the objects to be dried. The inlet 21a may be disposed in a position corresponding to the door 13.

The base 100 may form the bottom of the main body 10. The base 100 may include a bottom portion 110 in which the heat exchanger 41 is seated and a front wall portion 120 vertically connected to the bottom portion 110. The front wall portion 120 of the base 100 may protrude upward from the front area of the bottom portion 110 and may be vertically disposed.

The drum 30 may be rotatably provided inside the main body 10. For example, the front panel 21 and the rear panel 22 are disposed parallel to each other at a certain interval, and may rotatably support the drum 30.

The bottom portion 110 of the base 100 may include a first body 111 supporting the heat exchanger 41 upward, and a second body 112 coupled to the first body 111 to form a flow passage through which air flows. The second body 112 may be disposed above the first body 111, and a dehumidifier and a blowing fan 44 may be accommodated between the first and second bodies 111 and 112.

The heat exchanger 41 may heat the air supplied to the drum 30. High-temperature and humid air inside the drum 30 flows into the heat exchanger 41 along the inlet flow path. The high-temperature and dried air that passes through the heat exchanger 41 may be discharged back into the drum 30 along the discharge path, so that the air is circulated. This circulation of air may be induced by the blowing fan 44 disposed in the inlet flow path.

For example, the high-temperature and humid air discharged from the drum 30 flows into the heat exchanger 41 through the blowing fan 44. The heat exchanger 41 may include an evaporator and a condenser. The high-temperature and humid air may pass through the evaporator. A refrigerant that expands due to a pressure drop and absorbs heat may flow inside the evaporator. The refrigerant absorbs heat as it evaporates in the evaporator, and the high-temperature and humid air passing through the evaporator loses moisture as it cools and becomes low-temperature and dry air. That is, the high-temperature and humid air discharged from the drum 30 changes into low-temperature and dry air as it passes through the evaporator.

The low-temperature and dry air that passes through the evaporator may pass through the condenser. Superheated refrigerant compressed by the compressor 42 may flow inside the condenser. The superheated refrigerant releases heat while flowing through the condenser, and the low-temperature and dry air passing through the condenser is heated to become high-temperature and dry air. In other words, the low-temperature and dry air that passes through the evaporator changes into high-temperature and dry air as it passes through the condenser.

When the drying process begins, a driving part 43 operates so that the drum 30 and the blowing fan 44 are operated. The blowing fan 44 generates air flow. As the air passes through the heat exchanger 41, it may change into high-temperature and dry air and may flow into the drum 30. The high-temperature and dry air introduced into the drum 30 takes away moisture from the objects to be dried contained within the drum 30, thereby drying the objects to be dried. At the same time, the air changes into high-temperature and humid air. The high-temperature and humid air may flow back into the heat exchanger 41 along the inlet flow path and change into high-temperature and dry air. This high-temperature and dry air may be discharged back to the drum 30.

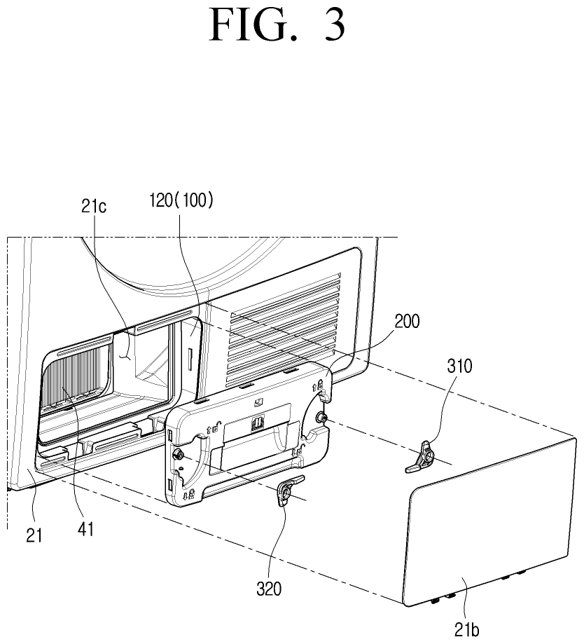

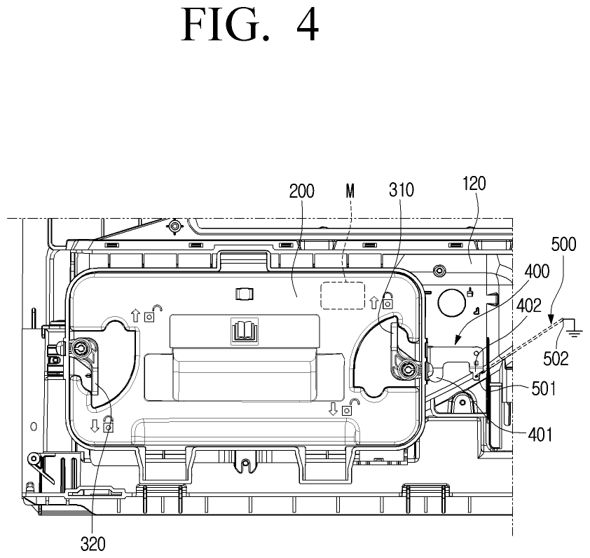

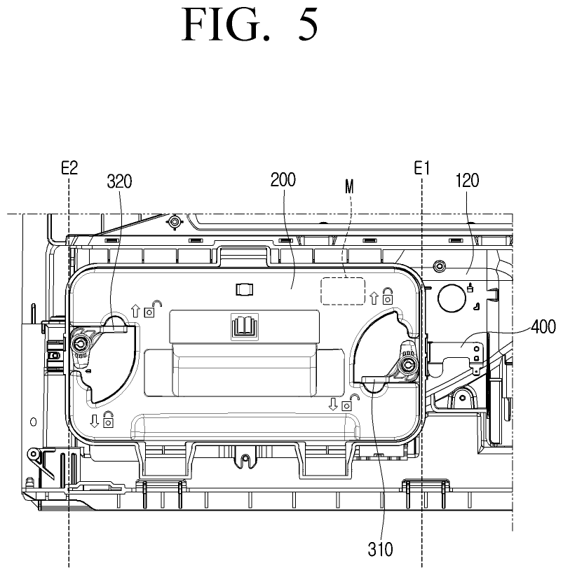

FIG. 3 is an exploded perspective view of a frame and a cover. FIG. 4 is a front view illustrating a state in which a fixer member is disposed in a first position. FIG. 5 is a front view illustrating a state in which a fixer member is disposed in a second position.

Referring to FIGS. 3 to 5, the front panel 21 may be provided with an opening 21c for access to the heat exchanger 41. The opening 21c of the front panel 21 may be formed at a position corresponding to the front wall portion 120 of the base 100 and the heat exchanger 41. The opening 21c of the front panel 21 may be formed on the lower portion of the front panel 21.

The dryer 1 may further include a cover 21b. The cover 21b may open and close the opening 21c of the front panel 21. The user may open the cover 21b to expose the opening 21c of the front panel 21 to the outside.

The dryer 1 according to an embodiment of the disclosure may include a base 100, a filter unit 200, a ground electrode 400, and a fixer member 310.

The base 100 may accommodate the heat exchanger 41, and the front wall portion 120 of the base 100 may expose the heat exchanger 41 to the outside.

The filter unit 200 may be disposed between the cover 21b and the heat exchanger 41. The filter unit 200 may be detachably mounted on the front wall portion 120 of the base 100 through the opening 21c of the front panel 21. The filter unit 200 has a substantially rectangular shape and may be disposed in the opening 21c of the front panel 21 so that the heat exchanger 41 is not exposed to the outside when the filter unit 200 is mounted on the front wall portion 120.

For example, when the user wants to clean the heat exchanger 41, the user may separate the cover 21b of the front panel 21 and the filter unit 200 from the main body 10 so as to open the opening 21c of the front panel 21.

The fixer member 310 may be coupled to the front wall portion 120 of the base 100 at the first position to prevent the filter unit 200 from being separated from the front wall portion 120 of the base 100. In addition, the fixer member 310 may be electrically connected to the ground electrode 400 at the first position.

The fixer member 310 may enable the filter unit 200 to be separated from the front wall portion 120 when the fixer member 310 rotates from the first position to the second position.

The fixer member 310 may be disposed on the front of the filter unit 200. The fixer member 310 may interfere with the front wall portion 120 in the first position and may not interfere with the front wall portion 120 in the second position.

The ground electrode 400 may be disposed on the front wall portion 120 of the base 100. The ground electrode 400 may be formed of stainless steel (STS). The ground electrode 400 may have a substantially U shape.

The ground electrode 400 may include one end 401 in contact with the fixer member 310 at the first position and the other end 402 electrically connected to a wire member 500. One end 401 of the ground electrode 400 may be disposed closer to the filter unit 200 than the other end 402 of the ground electrode 400.

When separating the filter unit 200 from the main body 10 to clean the heat exchanger 41, the user has no choice but to grip the fixer member 310 located at the first position. When the user grips the fixer member 310 located at the first position, static electricity charged to the user may be discharged through the fixer member 310 and the grounded ground electrode 400.

In other words, when the user cleans the heat exchanger 41, the static electricity charged to the user is discharged in advance, so the case where the static electricity and explosive refrigerant react with each other and ignite may be prevented.

The dryer 1 according to an embodiment of the disclosure may further include a wire member 500. The wire member 500 may include one end 501 that is electrically connected to the ground electrode 400 and the other end 502 that is grounded.

The wire member 500 may be connected to the main printed circuit board (PCB) of the dryer 1, or may be electrically connected to the ground line of the power cord that supplies power to the dryer 1, so that the wire member 500 may be grounded.

The fixer member 310 is rotatably connected to the filter unit 200, and may rotate from the first position in a first direction so as to move to the second position. In addition, the fixer member 310 may rotate from the second position in a second direction opposite to the first direction so as to move to the first position.

The fixer member 310 may rotate by 90 degrees in the first direction from the first position and move to the second position. In addition, the fixer member 310 may rotate by 90 degrees from the second position in the second direction opposite to the first direction and move to the first position.

The fixer member 310 may be formed of a conductive material. For example, the fixer member 310 may include chromium (Cr). The fixer member 310 may have an “L” shape.

The fixer member 310 may be disposed adjacent to a first edge E1 of the filter unit 200. The dryer 1 according to an embodiment of the disclosure may further include an additional fixer member 320. The additional fixer member 320 may be connected to the front of the filter unit 200 and disposed adjacent to a second edge E2 opposite to the first edge E1 of the filter unit 200.

The additional fixer member 320 may be coupled to the front wall portion 120 in a third position to prevent the filter unit 200 from being separated from the front wall portion 120. The additional fixer member 320 may enable the filter unit 200 to be separated from the front wall portion 120 in a fourth position rotated from the third position. That is, the additional fixer member 320 fixes the filter unit 200 to the front wall portion 120 by interfering with the front wall portion 120 of the base 100 at the third position. The additional fixer member 320 may enable to the filter unit 200 to be separated from the base 100 at the fourth position.

Referring to FIG. 4, the additional fixer member 320 is disposed at the third position. Referring to FIG. 5, the additional fixer member 320 is disposed at the fourth position. The first position and the third position may correspond to each other, and the second position and the fourth position may correspond to each other.

The user may rotate the fixer member 310 and the additional fixer member 320 to change the filter unit 200 into a state in which it may be separated from the front wall portion 120 of the base 100.

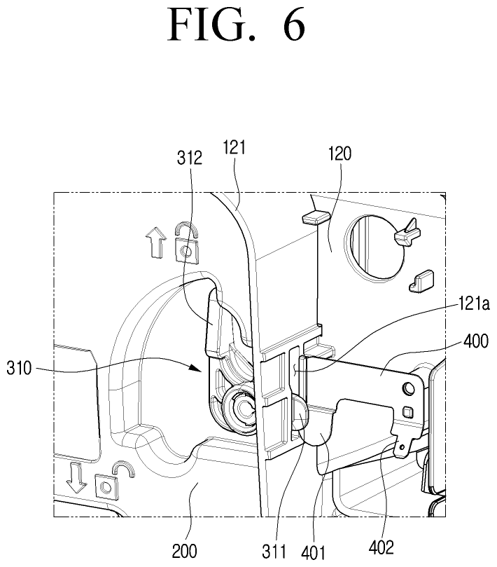

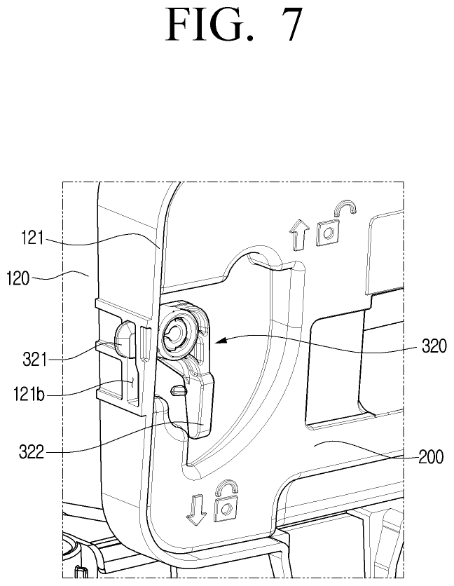

FIG. 6 is a perspective view illustrating a state in which a fixer member is disposed in a first position. FIG. 7 is a perspective view illustrating a state in which an additional fixer member is disposed in a first position.

The fixer member 310 may include a protruding area 311 disposed outside the filter unit 200 at the first position and in contact with the ground electrode 400. The fixer member 310 may include a gripping area 312 that is gripped by the user.

The protruding area 311 and the gripping area 312 may extend in directions perpendicular to each other from the rotation axis of the fixer member 310. The gripping area 312 may have a longer length than the protruding area 311.

The front wall portion 120 of the base 100 may include a side wall 121 disposed on one side of the filter unit 200 and including a through hole 121a. The protruding area 311 of the fixer member 310 may penetrate the through hole 121a at the first position.

The side wall 121 of the front wall portion 120 may be disposed to protrude further forward than the front of the filter unit 200 so as to surround the filter unit 200.

The additional fixer member 320 may include a protruding area 321 disposed outside the filter unit 200 at the third position. The additional fixer member 320 may include a gripping area 322 that is gripped by the user.

The protruding area 321 and the gripping area 322 may extend in directions perpendicular to each other from the rotation axis of the additional fixer member 320. The gripping area 322 may have a longer length than the protruding area 321.

The side wall 121 of the front wall portion 120 includes an additional through hole 121b. The protruding area 321 of the additional fixer member 320 may penetrate the additional through hole 121b at the third position.

Accordingly, as the fixer member 310 and the additional fixer member 320 interfere with the side wall 121 of the front wall portion 120, the filter unit 200 may be stably fastened to the front wall portion 120.

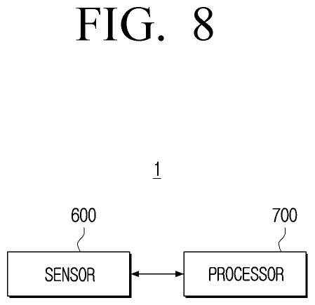

FIG. 8 is a functional block diagram of a dryer according to an embodiment of the disclosure.

Referring to FIG. 8, the dryer 1 according to an embodiment of the disclosure may further include a sensor 600 and a processor 700.

The sensor 600 may detect whether the fixer member 310 is in contact with the ground electrode 400.

When the processor 700 detects that the fixer member 310 is in contact with the ground electrode 400 through the sensor 600, the processor 700 may identify that the filter unit 200 is fastened to the front wall portion 120 of the base 100.

The dryer 1 according to an embodiment of the disclosure may further include a magnet member M disposed in the filter unit 200. In addition, the sensor 600 may be disposed on the front wall portion 120 of the base 100, and may detect the magnetic force of the magnet member M.

In this case, the processor 700 may identify that the filter unit 200 is fastened to the base 100 when the magnitude of the magnetic force of the magnet member M received from the sensor 600 is greater than or equal to a preset value.

When it is identified that the filter unit 200 is fastened to the base 100, the processor 700 may notify the user of this through a display or speaker. When it is identified that the filter unit 200 is not fastened to the base 100, the processor 700 may control the dryer 1 not to be operated.

In the above, preferred embodiments of the disclosure have been shown and described, but the disclosure is not limited to the specific embodiments described above. The disclosure may be modified and implemented by anyone skilled in the art without departing from the gist of the disclosure as claimed in the claims, and such changes are within the scope of the claims.

1. A dryer comprising:
a main body including a front panel including an opening and with an inlet through which objects to be dried are input, and a base forming a bottom surface;
a drum rotatable inside the main body; and
a heat exchanger configured to heat air supplied to the drum, the heat exchanger being accessible through the opening of the front panel,
wherein the base includes a bottom portion on which the heat exchanger is seated and a front wall portion vertical to the bottom portion and connected to the bottom portion,
wherein the base further includes,
a cover configured to open and close the opening that allows access to the heat exchanger;
a filter unit coupleable to and decouplable from the front wall portion through the opening; and
a ground electrode on the front wall portion,
wherein the filter unit includes a fixer member coupleable to the front wall portion such that while the fixer member is coupled to the front wall portion and while the fixer member is at a first position the filter unit is prevented from being separated from the front wall portion, and while the fixer member is moved to a second position from the first position the filter unit is separable from the front wall portion, and
wherein the fixer member is electrically connected to the ground electrode sat the first position.

2. The dryer of claim 1 further comprises:
a wire member including one end electrically connected to the ground electrode and another end being grounded.

3. The dryer of claim 1, wherein
the fixer member includes a protruding area outside the filter unit at the first position and in contact with the ground electrode.

4. The dryer of claim 1, wherein
the fixer member is configured to:
connect to the filter unit whereby the fixer member is rotatable while connected to the filter unit,
rotate from the first position in a first direction so as to move to the second position, and
rotate from the second position in a second direction opposite to the first direction so as to move to the first position.

5. The dryer of claim 4, wherein
the fixer member is configured to:
rotate by 90 degrees in the first direction from the first position so as to move to the second position, and
rotate by 90 degrees from the second position in the second direction opposite to the first direction so as to move the first position.

6. The dryer of claim 1, wherein
the fixer member has an “L” shape.

7. The dryer of claim 1, wherein
the front wall portion includes a side wall on one side of the filter unit, the side wall including a through hole, and
wherein one area of the fixer member penetrates the through hole at the first position.

8. The dryer of claim 1, wherein
the fixer member includes chromium (Cr).

9. The dryer of claim 1, wherein
the fixer member is adjacent to a first edge of the filter unit, and
the filter unit further includes an additional fixer member, wherein the additional fixer member is connected to a front of the filter unit, adjacent to a second edge opposite to the first edge of the filter unit, interferes with the front wall portion at a third position to fix the filter unit to the front wall portion, and enables the filter unit to be separated from the front wall portion at a fourth position.

10. The dryer of claim 1, wherein
the ground electrode is formed of stainless steel (STS).

11. The dryer of claim 1 further comprises:
a sensor configured to detect whether the fixer member is in contact with the ground electrode; and
a processor configured to identify that the filter unit is fastened to the front wall portion based on detecting that the fixer member is in contact with the ground electrode through the sensor.

12. The dryer of claim 1 further comprises:
a magnet member on the filter unit;
a sensor on the front wall portion to detect magnetic force of the magnet member, and
a processor configured to identify that the filter unit is fastened to the front wall portion based on a magnitude of the magnetic force of the magnet member received from the sensor is greater than or equal to a preset value.
